(19) United States
(12) Patent Application Publication
(10) Pub. No.: US 2023/0061912 A1
(43) Pub. Date: Mar. 2, 2023

(54) UNIFORM STABILIZED LIGHT SOURCE

(71) Applicant: TEXAS INSTRUMENTS INCORPORATED, Dallas, TX (US)

(72) Inventor: Karthik Rajagopal Ganapathy, Dallas, TX (US)

(21) Appl. No.: 17/578,219

(22) Filed: Jan. 18, 2022

Related U.S. Application Data
(60) Provisional application No. 63/240,222, filed on Sep. 2, 2021.

(51) Int. Cl. G05D 25/02; G01J 3/28; G01J 3/10

(52) U.S. Cl. CPC G05D 25/02; G01J 3/28; G01J 3/10

(57) ABSTRACT

In an example, a system includes a surface including one or more light sources and one or more sensors. The system also includes a dome structure configured to cover the surface. The system includes an output port on the surface configured to provide light from the one or more light sources to a device under test. The system also includes a controller coupled to the one or more sensors and configured to adjust the one or more light sources based at least in part on feedback from a sensor.

### CROSS-REFERENCE TO RELATED APPLICATIONS

The present application claims priority to U.S. Provisional Patent Application No. 63/240,222, which was filed Sep. 2, 2021, is titled “Uniform Stabilized Light Source,” and is hereby incorporated herein by reference in its entirety.

### BACKGROUND

Many types of electronic systems benefit from uniform illumination. Uniform illumination provides the same amount of brightness on all points of a surface. As one example, testing, probing, and calibration of photo-sensitive devices may be performed by illuminating one or more devices with a light source. Properly testing and calibrating the photo-sensitive devices requires uniformity of the illumination from the light source as well as stability of the illumination, which means that a constant intensity of the light is provided over a period of time.

### SUMMARY

In accordance with at least one example of the description, a system includes a surface including one or more light sources and one or more sensors. The system also includes a dome structure configured to cover the surface. The system includes an output port on the surface configured to provide light from the one or more light sources to a device under test (DUT). The system also includes a controller coupled to the one or more sensors and configured to adjust the one or more light sources based at least in part on feedback from a sensor.

In accordance with at least one example of the description, a system includes a first surface including one or more light sources and a second surface including one or more sensors. The system also includes a dome structure configured to cover the first surface and the second surface. The system includes an output port on the second surface configured to provide light from the one or more light sources to a DUT.

In accordance with at least one example of the description, a method includes providing light from a light source located on a surface, where the light is reflected off an inner surface of a dome structure covering the surface. The method also includes providing the light reflected off the inner surface of the dome structure to an electronic device through an output port on the surface. The method includes sensing the light reflected off the inner surface of the dome structure with a sensor located on the surface. The method also includes, responsive to sensing the light, adjusting the light provided by the light source with a controller.

### BRIEF DESCRIPTION OF THE DRAWINGS

FIG. 1 is a system for a uniform stabilized light source in accordance with various examples.

FIG. 2 is a system for a uniform stabilized light source in accordance with various examples.

FIG. 3 is a system for a uniform stabilized light source in accordance with various examples.

FIG. 4 is a system for a uniform stabilized light source in accordance with various examples.

FIG. 5 is a flow diagram of a method for providing a uniform stabilized light source in accordance with various examples.

FIG. 6 is a flow diagram of a method for providing a uniform stabilized light source in accordance with various examples.

The same reference numbers or other reference designators are used in the drawings to designate the same or similar (functionally and/or structurally) features. The drawings may not accurately reflect the size or scale of the features shown in the drawings.

### DETAILED DESCRIPTION

Uniform stable reference light sources are used for testing and calibration of photo-sensitive devices, such as light sensors. Uniformity of the light source may be achieved by using diffusers, multiple light sources, or integrating spheres. Integrating spheres are spherical shaped enclosures that have an input port where light is provided to the interior of the sphere. The integrating sphere has an output port where a device under test (DUT) may receive light reflected off the interior walls of the sphere. The integrating sphere also has one or more feedback sensors on its interior to measure the light inside the sphere. Light enters the sphere via the input port, reflects off the interior walls of the sphere, and then exits the sphere at the output port, where the light illuminates the DUT. Integrating spheres may have high cost, power usage, and space requirements. Also, it can be difficult to test more than one device or include more than one feedback sensor on the interior of the sphere, as the presence of the feedback sensor or the output port reduces the efficiency and power of the light reflected on the inner walls of the sphere.

Stability of light sources may be achieved with an analog feedback system, but these systems are sensitive to temperature and spectral shifts. Analog feedback systems also need periodic calibration. If a single light source illuminates a group of photo-sensitive devices for testing, there may be variations in the amount of light that reaches each sensor. Calibration would need to be performed for each sensor position. A mirror could be useful for redirecting some of the light from the light source to a sensor for calibration, but this process reduces the efficiency of the light source. Additionally, light source output may drift over time as light sources age, or may drift due to irregularities during operation.

In examples herein, a hemispherical dome structure includes a light output port on the circular plane of the hemisphere. A closed three-dimensional shape is cut in half (or cut approximately in half in some examples) by a plane, where the plane includes the optical and electrical components for controlling the system, as well as the output port to provide light to the device or devices under test. The plane may include light sources, light sensors, temperatures sensors, and/or any other suitable circuitry. The inner surface of the hemispherical dome structure may be a matte or diffusely reflecting surface, which exhibits Lambertian reflectance. The brightness of a Lambertian surface is the same regardless of an observer's angle of view. The light that exits the output port is an integrated version of the light provided by the light sources due to the Lambertian reflectance of the inner surface of the dome structure. The light sources may be any type of light source, such as light emitting diodes (LEDs), lasers, halogen lights, incandescent lights, etc. Examples herein may also include a control system for digital or analog compensation of the light sources. A microcontroller coupled to the light sources may receive feedback from one or more sensors and stabilize the light sources by adjusting their currents or intensities. The sensors may include temperature sensors in an example. Some examples herein describe a hemispherical dome structure, but structures of other shapes may be useful as well.

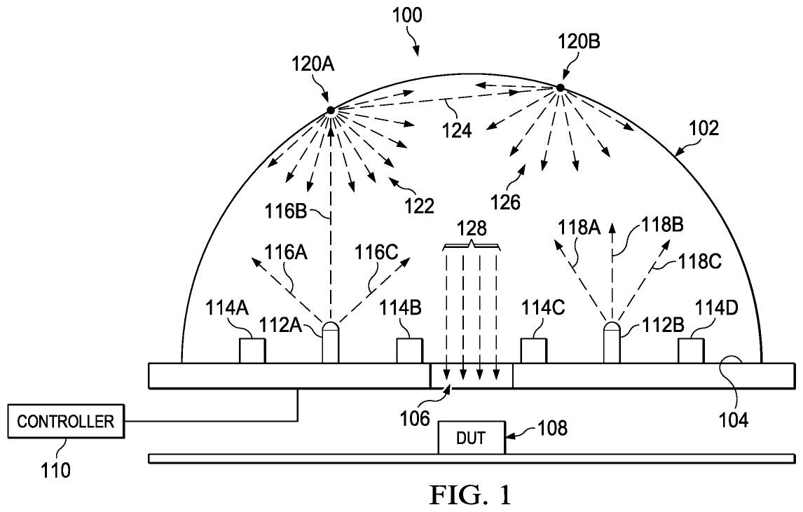

FIG. 1 illustrates a system 100 for a uniform stabilized light source in accordance with various examples herein. System 100 includes a dome structure 102, which in this example is a hemispherical dome structure. System 100 also includes a surface 104, which could be a printed circuit board (PCB) that contains one or more electronic components. Surface 104 includes an output port 106. System 100 includes a DUT 108 and a controller 110. In some examples, surface 104 is a plane that bisects the dome structure 102 to produce a hemispherical, hemi-ellipsoid, or other hemi-structure of a three-dimensional shape. In other examples, surface 104 may divide the dome structure 102 into unequal (e.g., non-bisected) parts along any plane that passes through dome structure 102. The dome structure 102 may be a portion of a sphere, such as a hemisphere, or may be a portion of another shape, such as a hemi-ellipsoid. The dome structure 102 may be approximately half the size of the full shape in some examples, such as a hemisphere shape that is approximately half the size of the full spherical shape.

Surface 104 may exhibit Lambertian reflectance and may include light sources 112A and 112B (collectively, light sources 112). Two light sources 112 are shown in this example, but any number of light sources 112 may be useful in other examples. Surface 104 also includes one or more sensors, such as sensors 114A, 114B, 114C, and 114D (collectively, sensors 114). As an example, the light produced by light sources 112 is represented by light rays 116A, 116B, and 116C for light source 112A, and light rays 118A, 118B, and 118C for light source 112B. Points 120A and 120B represents points on the inside surface of dome structure 102. Light rays reflected from point 120A are represented by light rays 122. Light ray 124 is also a light ray reflected from point 120A to point 120B. Light rays reflected from point 120B are represented by light rays 126. Light 128 represents the integrated light that leaves output port 106 and is provided to DUT 108.

In operation, light sources 112 produce light in system 100. Light rays from light sources 112, such as light rays 116 and 118, are emitted and strike the inner surface of dome structure 102. As one example, light ray 116B strikes dome structure 102 at point 120A. In some examples, the inner surface of dome structure 102 has a white matte finish or is painted with a white matte paint, such as a barium sulfate paint, with a high reflectance. Light rays are reflected off the inner surface of dome structure 102, in all directions, such as light ray 124 reflecting from point 120A to point 120B. At point 120B and every other point on the inner surface of dome structure 102, light rays are reflected again in all direction, such as light rays reflected from point 120B. The light rays reflected off the high reflectance inner surface of dome structure 102 produces integrated light 128. Integrated light 128 is a normalized light that is provided to the DUT 108 via output port 106. Integrated light 128 is a uniform light that is a combination of light from all light sources 112, and is reflected all across surface 104 as well as through output port 106.

Sensors 114 may sense light from light sources 112, such as the integrated light 128 that is reflected throughout the inner volume of the dome structure 102. Sensors 114 may not be present in all examples. Sensors 114 could be analog or digital sensors. In one example, one or more of sensors 114 are light sensors. Light sensors sense the light reflected onto the sensor 114 and provide a signal representing the sensed light to controller 110. Controller 110 may adjust the light provided by light sources 112 based on one or more signals from sensors 114. For example, if the light received at a sensor 114 falls below a predetermined threshold, controller 110 may communicate with light sources 112 and increase the light provided by light sources 112. Controller 110 may be any type of microcontroller or microprocessor. Controller 110 may be a proportional-integral-derivative (PID) controller in one example. Controller 110 may include logic, digital and/or analog circuitry, firmware, software, input and output ports, or any other suitable components for receiving data from sensors 114 and for controlling light sources 112.

Sensors 114 may also include temperature sensors in some examples. Temperature sensors may be useful for determining a local temperature at specific locations of surface 104, or for determining an average temperature of surface 104. Temperature data may be provided to controller 110 by sensors 114 and controller 110 may adjust light sources 112 based on the temperature data. Sensors 114 may include a spectrometer that measures the wavelength of the light produced by light sources 112 and reflected onto sensors 114. The wavelength of the light may be provided to controller 110 by a sensor 114, and controller 110 may adjust the wavelength of one or more light sources 112 in response. As an example, light sources 112 may provide red, green, and blue light, and controller 110 may adjust light sources 112 to provide a specific mix of red, green, and blue light produced by the light sources 112. In other examples, light sources 112 may provide near infrared or UV light, and controller 110 may adjust light sources 112 to provide a specific mix of these types of light.

Sensors 114 may be placed anywhere on surface 104. In some example, sensors 114 may be light sensors placed close to output port 106. By placing sensors 114 close to output port 106, the sensors may provide a close approximation of the integrated light 128 that passes through output port 106. As one example, system 100 includes sensors 114B and 114C near the edges of output port 106. Placing sensors 114 close to output port 106 allows controller 110 to receive information regarding integrated light 128 without blocking integrated light 128 from exiting via output port 106. If sensors 114 are temperature sensors, sensors 114 may be placed at any suitable distance from light sources 112 to provide appropriate temperature data. Other types of sensors may be placed anywhere on surface 104.

Output port 106 may have a circular shape in some examples. A circular shape may produce a more uniform light output from output port 106 than other shapes. However, other shapes may be used in other examples. For example, output port 106 may have an oval shape or a polygonal shape. Output port may have a shape with rounded corners in some examples. In other examples, output port 106 may be designed to provide a particular light profile on the X-Y surface where DUT 108 resides. The shape of output port 106 could be designed to provide that particular light profile in those examples. In some examples, output port 106 is an opening in the material that forms surface 104. In other embodiments, output port 106 includes a light-transmissive or other material formed in the opening in the material that forms surface 104.

In system 100, dome structure 102 has a hemispherical shape. Dome structure 102 may have any suitable shape in other examples. Dome structure 102 may have a parabolic, hemi-icosahedron, or hemi-ellipsoidal shape in some examples. An enclosed shape with smooth inner surfaces provides good light uniformity and stability in some examples.

DUT 108 could be one device or more than one device. DUT 108 may include a bank of similar devices in some examples, so the multiple devices may be tested at the same time. DUT 108 may include different types of devices in some examples. DUT 108 could be a photo-sensitive device in some examples, and system 100 may be used for calibration, testing, or trimming of DUT 108.

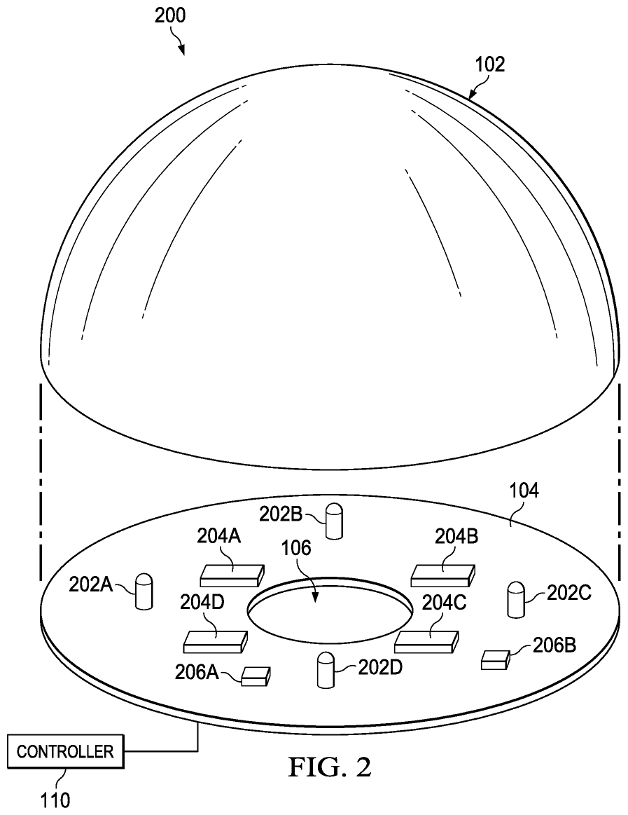

FIG. 2 is a system 200 for a uniform stabilized light source in accordance with various examples herein. System 200 includes a dome structure 102, which in this example is a hemispherical dome structure. System 200 also includes a surface 104, which could be a PCB or other surface that contains one or more electronic components. Surface 104 includes an output port 106. System 100 includes a controller 110. A DUT is not shown in this example. System 200 also includes light sources 202A, 202B, 202C, and 202D (collectively, light sources 202). System 200 includes light sensors 204A, 204B, 204C, and 204D (collectively, light sensors 204). System 200 includes sensors 206A and 206B (collectively, sensors 206). In some examples, light sources 202 are similar to light sources 112. Also, in some examples, sensors 204 and/or 206 are similar to sensors 114.

FIG. 2 provides a perspective view of system 200 that shows dome structure 102 separated from surface 104. In operation, dome structure 102 would sit atop surface 104 and provide an enclosure, as represented by the arrows in FIG. 2. In some examples, dome structure 102 may be affixed to surface 104. System 200 operates similarly to system 100 described above. Controller 110 controls light sources 202, and light sources 202 produce light that is reflected off the inner surface of dome structure 102 to produce uniform lighting through output port 106. In this example, light sources 202 are LED light sources, but any other type of light source may be used in other examples. Four light sensors 204 are situated approximately uniformly around output port 106 in this example. While four light sensors 204 are shown in system 200, any number of light sensors, in any configuration, may be present in other examples. Placing light sensors 204 near output port 106 allows light sensors 204 to provide an approximation of the light that is provided through output port 106 to the DUT. Light sensors 204 provide feedback to controller 110, and controller 110 can control light sources 202 to alter the output of light sources 202 based at least in part on the feedback.

System 200 also includes sensors 206. Sensors 206 may also be light sensors in this example, but could also be other types of sensors. In one example, sensors 206 are temperature sensors. Sensors 206 may provide temperature readings to controller 110, and controller 110 may alter light sources 202 based at least in part on the temperature readings. Sensors 206 could be other types of sensors, such as spectrometers. Two sensors 206 are shown in system 200, but any number of sensors 206 and/or any other configuration of sensors 206 may be present in other examples.

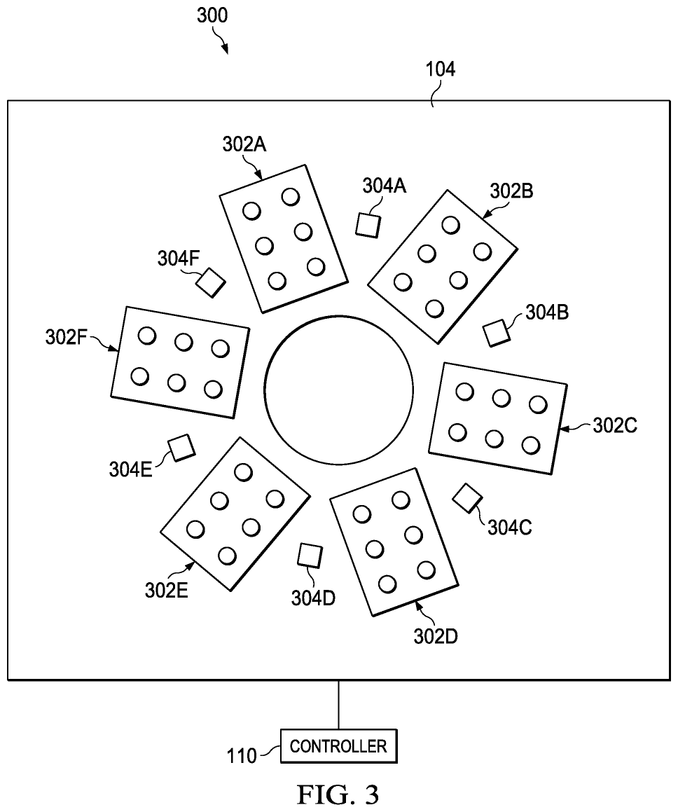

FIG. 3 is a system 300 for a uniform stabilized light source in accordance with various examples herein. System 300 includes a surface 104 and controller 110. The material used to form surface 104 may be a single-layer or multi-layer printed circuit board, so that controller 110 may be situated on the opposite surface of surface 104 or it may be situated within the multi-layer circuit board. If a multi-layer circuit board is used, contacts may be formed through the PCB so that connections to the light sources and/or sensors can be formed so as to electrically connect the light sources and/or sensors to controller 110 and any other electronic devices. An overhead view of surface 104 is shown. Surface 104 includes an output port 106 and light sources 302A, 302B, 302C, 302D, 302E, and 302F (collectively, light sources 302). In this example, light sources 302 are banks of LEDs. Surface 104 also includes light sensors 304A, 304B, 304C, 304D, 304E, and 304F (collectively, light sensors 304).

System 300 shows one configuration of light sources 302 and light sensors 304. In other examples, light sensors 304 may include one or more light sensors, temperature sensors and/or spectrometers. The light sources 302 and light sensors 304 are placed approximately uniformly around output port 106. Light sensors 304 sense the light that reaches the light sensor 304 and provides feedback to controller 110. Controller 110 may alter the output of light sources 302 based at least in part on the feedback from the light sensors 304. Although not shown in system 300, other types of sensors may be present in other examples, such as temperature sensors or spectrometers.

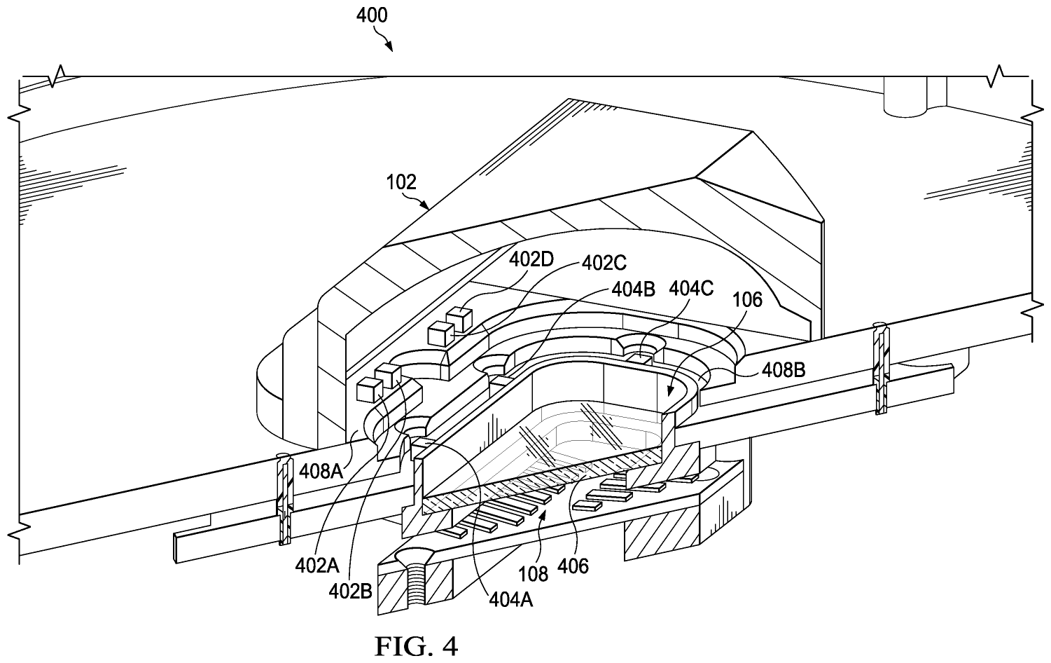

FIG. 4 is a system 400 for a uniform stabilized light source in accordance with various examples herein. FIG. 4 provides a perspective cross-section view of system 400. System 400 is a testing setup for one or more DUTs in an example. System 400 includes a dome structure 102, output port 106, DUTs 108, and light sources 402A, 402B, 402C, and 402D (collectively, light sources 402). System 400 also includes light sensors 404A, 404B, and 404C (collectively, light sensors 404), surface 408A, and surface 408B.

In system 400, multiple DUTs 108 are placed beneath output port 106 for testing. Diffuser 406 resides within output port 106 to diffuse or scatter the light provided to DUTs 108 through output port 106. In this example, the internal shape of dome structure 102 is a hemi-ellipsoidal dome, and output port 106 is rectangular with rounded corners. Other shapes may be used in other examples.

In system 400, light sources 402 produce light, which is reflected off the inner surface of dome structure 102 and provided to DUTs 108 via output port 106. Light sensors 404 are placed near output port 106 and provide a measurement of the light near output port 106 to a controller (not shown in FIG. 4). In this example, light sources 402 are placed on a first surface 408A, and light sensors are on a second surface 408B. Therefore, the surface that contains the electronic components (such as light sources and sensors) may have multiple layers or surfaces in some examples. As an example, surface 104 in the above examples may have multiple layers, similar to surfaces 408A and 408B in system 400. Electronic components, such as light sources and sensors, may be placed in any suitable configuration on the multiple surfaces in accordance with various examples herein.

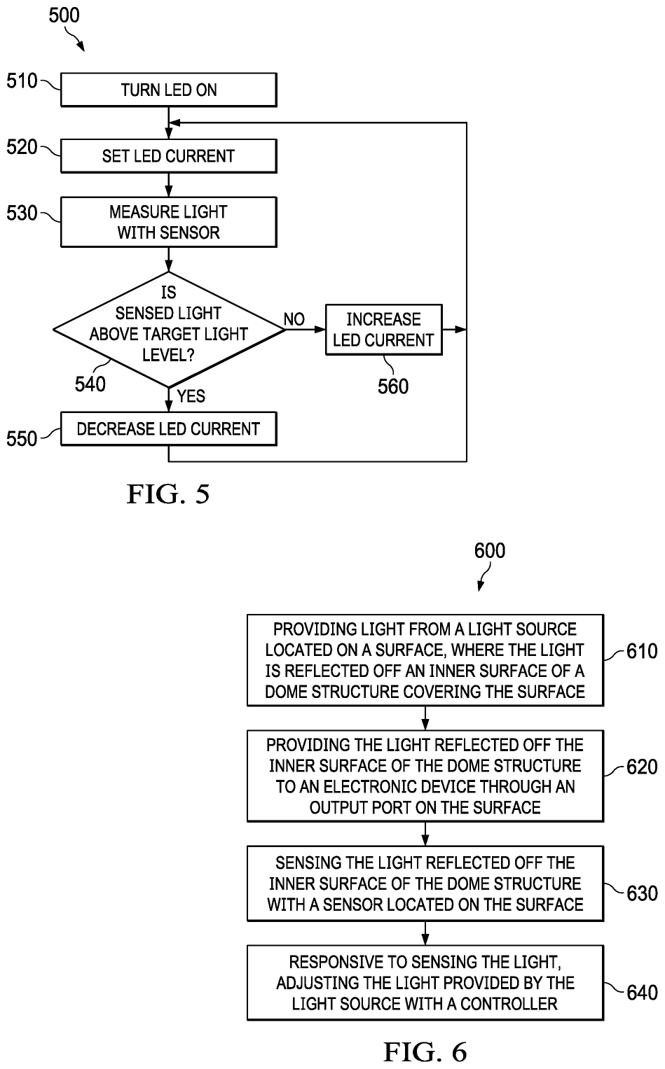

FIG. 5 is a flow diagram of a method 500 for providing a uniform stabilized light source in accordance with various examples herein. The steps of method 500 may be performed in any suitable order. The hardware components described above with respect to FIGS. 1-4 may perform method 500 in some examples.

Method 500 begins at 510, where a light source 112 such as an LED is turned on. The LED may be located on a surface such as surface 104. Controller 110 may turn on the LED in one example. The light source and surface may be located within a dome structure that covers the surface and produces an integrated light from the light reflected off the inner surface of the dome structure.

Method 500 continues at 520, where controller 110 sets the LED current. Setting the LED current sets the amount of light output by the LED. More current provided to the LED produces a higher light output, and less current provided to the LED produces a lower light output.

Method 500 continues at 530, where light output by the LED is measured with a light sensor. The light sensor may be located on surface 104. The light sensor may be placed near an output port on surface 104, such as output port 106. The light sensor may provide a measurement of the integrated light produced by the light sources, after the light has reflected off the inner surface of the dome structure.

Method 500 continues at 540, where the method determines if the light sensed by the light sensor is above a target light level. Controller 110 may make this determination using feedback from the light sensors. If the light is above the target light level, the method 500 continues to 550. In some examples, if the light is around the target light level, the current to the light source(s) may be maintained.

At 550, controller 110 decreases LED current if the light is above the target light level. The method then returns to 520, where the LED current is set at a lower level. A lower LED current reduces the amount of light produced by the light source. The method then continues from 520, where light is continually sensed by the sensors and provided to controller 110. Controller 110 uses this feedback to provide a stable light source.

Returning to 540, if the controller determines the sensed light is not above the target light level, the method proceeds to 560. At 560, controller 110 increases LED current if the light is below the target light level. The method then returns to 520, where the LED current is set at a higher level. A higher LED current increases the amount of light produced by the light source. The method then continues from 520, where light is continually sensed by the sensors and provided to controller 110. Controller 110 uses this feedback to provide a stable light source.

In another example, a method similar to method 500 could be useful for adjusting temperature or wavelength. Temperature may be sensed with temperature sensors, and light sources could be adjusted based on the sensed temperature. Also, wavelength of the light could be sensed and the light sources could be adjusted based on the sensed wavelength.

FIG. 6 is a flow diagram of a method 600 for providing a uniform stabilized light source in accordance with various examples herein. The steps of method 600 may be performed in any suitable order. The hardware components described above with respect to FIGS. 1-4 may perform method 600 in some examples.

Method 600 begins at 610, where a light source located on a surface provides light, where the light is reflected off an inner surface of a dome structure covering the surface. The dome structure may be a hemisphere in one example. The light source may be any type of light source, such as laser, LED, halogen, incandescent, etc.

Method 600 continues at 620, where the light reflected off the inner surface of the dome structure is provided to an electronic device through an output port on the surface. The inner surface of the dome structure may be a matte surface that produces approximately Lambertian reflectance. One or more electronic devices may receive the light through the output port.

Method 600 continues at 630, where a light sensor located on the surface senses the light reflected off the inner surface of the dome structure. The light sensor may be located anywhere on the surface, and in some examples the light sensor is located near the output port. More than one light sensor may sense the light and provide feedback to a controller.

Method 600 continues at 640, where responsive to sensing the light, the controller adjusts the light provided by the light source. The controller may increase or decrease the light provided by the light sources to achieve a light output that matches a predetermined target level. In other examples, temperature or wavelength may be sensed by sensors, and the controller may adjust the light sources based at least in part on the sensed temperature or wavelength.

In examples herein, a uniform and stable light source is provided to one or more DUTs. A dome structure reflects light from light sources onto the DUTs. A controller and one or more sensors provide a control loop to provide stability of the light sources. Uniform light is provided to the DUTs by light reflecting off the inner surface of the dome structure to produce integrated light at an output port. Examples herein provide uniform and stable light at a lower cost and volume than an integrating sphere. An entire circular plane or PCB may be utilized to place light sources, sensors, and the output port. Digital sensors may provide a temperature compensated feedback loop that produces a stable light source in a variety of conditions. Light output may be monitored by examples herein without diverting light away from the DUTs.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means+/−10 percent of the stated value. Modifications are possible in the described examples, and other examples are possible within the scope of the claims.

What is claimed is:

1. A system, comprising:
a surface including one or more light sources and one or more sensors;
a dome structure configured to cover the surface;
an output port on the surface configured to provide light from the one or more light sources to a device under test (DUT); and
a controller coupled to the one or more sensors and configured to adjust the one or more light sources based at least in part on feedback from a sensor.

2. The system of claim 1, wherein an inner surface of the dome structure includes a matte finish.

3. The system of claim 1, wherein the output port is configured to provide a uniform lighting to the DUT.

4. The system of claim 1, wherein the dome structure is a hemisphere.

5. The system of claim 1, wherein the output port has a circular shape.

6. The system of claim 1, wherein the one or more sensors includes a light sensor.

7. The system of claim 1, wherein the one or more sensors includes a temperature sensor.

8. The system of claim 1, wherein an inner surface of the dome structure is configured to provide an approximately Lambertian reflectance.

9. The system of claim 1, wherein the one or more sensors includes a spectrometer.

10. The system of claim 1, wherein the one or more light sources includes a light emitting diode (LED).

11. A system, comprising:
a first surface including one or more light sources and a second surface including one or more sensors;
a dome structure configured to cover the first surface and the second surface; and
an output port on the second surface configured to provide light from the one or more light sources to a device under test (DUT).

12. The system of claim 11, wherein the one or more sensors includes a light sensor, and the system further comprises:
a controller coupled to the light sensor and configured to adjust the one or more light sources based at least in part on feedback from the light sensor.

13. The system of claim 11, wherein the first surface is a plane that bisects the dome structure.

14. The system of claim 11, wherein the output port is configured to provide a uniform lighting to the DUT.

15. The system of claim 11, wherein the output port includes a diffuser.

16. The system of claim 11, wherein the one or more sensors includes a temperature sensor.

17. A method, comprising:
providing light from a light source located on a surface, wherein the light is reflected off an inner surface of a dome structure covering the surface;
providing the light reflected off the inner surface of the dome structure to an electronic device through an output port on the surface;
sensing the light reflected off the inner surface of the dome structure with a sensor located on the surface; and
responsive to sensing the light, adjusting the light provided by the light source with a controller.

18. The method of claim 17, further comprising:
sensing temperature with a temperature sensor located on the surface; and
responsive to sensing the temperature, adjusting the light provided by the light source with the controller.

19. The method of claim 17, further comprising:
sensing a wavelength of the light reflected off the inner surface of the dome structure; and
responsive to sensing the wavelength, adjusting the light provided by the light source with the controller.

20. The method of claim 17, wherein the inner surface of the dome structure includes a matte finish.
